(19) United States
(12) Patent Application Publication
(10) Pub. No.: US 2008/0233254 A1
(43) Pub. Date: Sep. 25, 2008

(54) LIQUID HEMP BEVERAGE CONCENTRATE EXTRACTION

(76) Inventor: Michael Fata, Manitoba (CA)

Correspondence Address: ADE & COMPANY INC., 2157 Henderson Highway, WINNIPEG, MB, R2G1P9, CA

(21) Appl. No.: 12/053,843

(22) Filed: Mar. 24, 2008

Related U.S. Application Data
(60) Provisional application No. 60/896,301, filed on Mar. 22, 2007.

(51) Int. Cl. A23L 2/385

(52) U.S. Cl. 426/431

(57) ABSTRACT

A process for preparing a liquid concentrate from hemp seed is described.

### PRIOR APPLICATION INFORMATION

The instant application claims the benefit of U.S. Provisional Patent Application 60/896,301, filed Mar. 22, 2007.

### SUMMARY OF THE INVENTION

According to an aspect of the invention, there is provided a method for preparing liquid concentrate from hemp seed comprising:

providing a quantity of hemp seed

washing the seed

mixing the washed seed with water

grinding the water and seed mixture, thereby producing a slurry;

screening the slurry to remove fiber; and

recovering the extract.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a process for preparing a liquid concentrate from hemp seed.

In a preferred embodiment, the process comprises:

providing a quantity of hemp seed

washing the seed

mixing the washed seed with water

grinding the water and seed mixture, thereby producing a slurry;

screening the slurry to remove fiber; and

recovering the extract.

The hemp seed may be whole hemp seed or shelled hemp seed. It is of note that in the example provided herein, whole hemp seed is used; however, in alternative embodiments, seed that has the shell removed may be used. As will be appreciated by one of skill in the art, when using shelled seed, washing is not required.

The seed may be washed by any means known in the art. In a preferred embodiment, the seed is washed under high pressure water, over 30 mesh screens, until the water comes out clean. This step is done to remove any of the dirt or dust on the seed prior to processing into a hemp concentrate.

As discussed above, the washed seed is mixed with the water at a ratio of at least 3 kg water per kg seed or at least 4 kg water per kg seed or at a ratio between 3 kg water per kg seed to 8 kg water per kg seed. In a preferred embodiment, seed is mixed with water at a ratio of approximately 4 kg water to approximately 1 kg seed.

In some embodiments, the approximately 4:1 ratio is preferred for making a concentrate. In these embodiments, significantly less than 4:1 may result in less than preferred levels of protein or fat being extracted from the seed. Furthermore, significantly more than the 4:1 ratio and you are not making a concentrate, but will make a milk. It is of note that while it may take longer to filter the shell out of the milk, the process described herein can also be used to prepare a milk.

It is of note that a ratio of water:seed below 3:1 produces what is effectively a paste whereas a ratio above 8:1 produces a solution that is too dilute.

As will be appreciated by one of skill in the art, preswelling requires soaking seeds in water for several hours. It is of note that in the instant invention, the mixture of water and seed is processed prior to significant preswelling occurring. It is of note that in the instant process, processing prevents bitterness in the milk.

The seed and water are ground together, to produce a slurry. An inline grinder is used. This step is done to break down the fat and protein in the seed, as they are the desired part of the extract. As will be appreciated by one skilled in the art, a wet grind is essential so that suitable levels of the fat and protein go into the water, thereby producing a slurry comprising ground seed, water and solubilized fat and protein.

In some embodiments, the water and seed mixture is ground by an inline, instant grinder. Specifically, in these embodiments, the water and seed mixture flows through the grinder and the propelling blade pushes the product through a screen that reduces the particle size. The grinder is arranged so that all the endosperm of the seed is broken, thereby producing a slurry.

In one embodiment, the slurry is screened by passing the slurry through a a vibratory screener. This step is done to remove the carbohydrate (fiber) material from the extract. The liquid that passes through the smallest screen is the extract. In other embodiments, filtering may be done by other means known in the art, for example, by centrifuge or membrane filtration.

Preferably, the milk or extract is separated from the ground seed remnants or mash as quickly as possible, for example, within 5 minutes of grinding.

The screened extract may then be pasteurized immediately or may be stored for a short period of time prior to pasteurization.

It is further of note that the above process is carried out at 1-30° C. This is in contrast with for example Canadian Patent Application 2,505,350 which teaches that mashing and extracting should be done at a temperature between 80-90° C. However, the inventors have found that heating does not work with the instant process as it brings out bitterness in the milk.

### Typical Nutritional Info for 100 g of Extract

Fat—3-8 g
Protein—2-5 g
Sugar—1-2 g
Fiber—1-2 g

While the preferred embodiments of the invention have been described above, it will be recognized and understood that various modifications may be made therein, and the appended claims are intended to cover all such modifications which may fall within the spirit and scope of the invention.

1. A method for preparing liquid concentrate from hemp seed comprising:
providing a quantity of hemp seed
washing the seed
mixing the washed seed with water
grinding the water and seed mixture, thereby producing a slurry;
screening the slurry to remove fiber; and
recovering the extract.

2. The method according to claim 1 wherein the seed is whole seed or shelled seed.

3. The method according to claim 1 wherein the washed seed is mixed with water at a ratio of at least 3:1.

4. The method according to claim 1 wherein the washed seed is mixed with water at a ratio of between approximately 3:1 to approximately 8:1.
